(19) United States
(12) Patent Application Publication
(10) Pub. No.: US 2020/0068917 A1
(43) Pub. Date: Mar. 5, 2020

(54) System and Method of Manufacturing a Butter Coffee Formulation

(71) Applicant: James William Brewer, III, Manitou springs, CO (US)

(72) Inventor: James William Brewer, III, Manitou springs, CO (US)

(21) Appl. No.: 16/559,307

(22) Filed: Sep. 3, 2019

Related U.S. Application Data
(60) Provisional application No. 62/726,036, filed on Aug. 31, 2018.

(51) Int. Cl. A23F 5/14; A23L 33/105; A47J 31/42

(52) U.S. Cl. CPC A23F 5/14; A47J 31/42; A23L 33/105

(57) ABSTRACT

A method of manufacturing a butter coffee formulation produces a full-bodied and smooth cup of coffee as a result of a specified roasting process. The method includes a quantity of dried coffee beans, a quantity of butter, a roasting machine, and a cooling tray. The method begins by placing the quantity of dried coffee beans into the roasting machine. The quantity of dried coffee beans is then transformed into a quantity of toasted coffee beans with the roasting machine. In order too cool the quantity of roasted coffee beans, the quantity of roasted coffee beans is removed from the roasting machine onto the cooling tray. The quantity of roasted coffee beans is cooled for a shortened time period before the quantity of butter is applied at a liquification temperature to the quantity of roasted coffee beans. The final product is further cooled for an extended time period.

The current application claims priority to U.S. provisional application Ser. No. 62/726,036 filed on Aug. 31, 2018. The current application is filed on the next business day, which is Sep. 3, 2019, while Aug. 31, 2019 was on a weekend and Sep. 2, 2019 was on a national holiday Labor Day.

### FIELD OF THE INVENTION

The present invention generally relates to manufacturing a butter coffee formulation. More specifically, the present invention produces a quantity of robust roasted coffee beans.

### BACKGROUND OF THE INVENTION

Caffeinated drinks are some of the most popular and consumed drinks in the world. Drinking at least one cup of coffee a day is part of most people's lives. Various caffeinated drinks and recipes have been available public throughout the years. From varying levels of caffeine drinks to caffeinated drinks infused with different flavors, people have multiple options to enjoy caffeinated drinks. A recent trend in the coffee world is butter coffee. In general, butter coffee is composed of butter, preferably unsalted, and coffee, preferably dark coffee. Sometimes, additional ingredients such as oil and sweeteners are added to the butter coffee depending on the preferences of a user. Butter coffee is generally accredited to provide more balanced levels of energy spread along longer periods of time. Some of the supporters of butter coffee claim butter coffee assists in weight diets, mental acuity, and mental focus. While many variations of butter coffee have been provided to the public, no recipe or butter coffee product have been provided to the public which provide butter coffee in single servings which can be prepared anywhere and on the go.

An objective of the present invention is to provide butter coffee formulation and related methods of roasting. The present invention provides a specific roasting process that enhances the coffee flavor of the quantity of dried coffee beans and provides a creamy, full texture.

### BRIEF DESCRIPTION OF THE DRAWINGS

FIG. 1 is a schematic view for a mixture of the present invention.

FIG. 2 is a schematic view for a system of the present invention.

FIG. 3 is a flowchart illustrating the overall process for a method of the present invention.

FIG. 4 is a flowchart illustrating the subprocess for pre-heating a roasting machine at a specified pre-heating temperature for a quantity of dried coffee beans of the present invention.

FIG. 5 is a flowchart illustrating the subprocess for automatically increasing the internal temperature of the roasting machine in order to accurately roast the quantity of dried coffee beans of the present invention.

FIG. 6 is a flowchart illustrating the subprocess for gradually roasting a quantity of dried coffee beans from 220 degrees Fahrenheit to 275 degrees Fahrenheit of the present invention until the first crack for the quantity of dried coffee beans.

FIG. 7 is a flowchart illustrating the subprocess for gradually roasting a quantity of dried coffee beans from 275 degrees Fahrenheit to 300 degrees Fahrenheit of the present invention until the first crack for the quantity of dried coffee beans.

FIG. 8 is a flowchart illustrating the subprocess for gradually roasting a quantity of dried coffee beans from 300 degrees Fahrenheit to 350 degrees Fahrenheit of the present invention.

FIG. 9 is a flowchart illustrating the subprocess for gradually roasting a quantity of dried coffee beans from 350 degrees Fahrenheit to 375 degrees Fahrenheit of the present invention until the first crack for the quantity of dried coffee beans.

FIG. 10 is a flowchart illustrating the subprocess for gradually roasting a quantity of dried coffee beans from 375 degrees Fahrenheit to 402 degrees Fahrenheit of the present invention to ensure a concentrated flavor for a quantity of roasted coffee beans.

FIG. 11 is a flowchart illustrating the subprocess for roasting the quantity of dried coffee beans with a specified final-roasting temperature of 402 degrees Fahrenheit of the present invention.

FIG. 12 is a flowchart illustrating the subprocess for cooling the quantity of roasted coffee beans for 2 minutes before heating the quantity of roasted coffee beans once again with a quantity of butter at a liquification temperature of the present invention.

FIG. 13 is a flowchart illustrating the subprocess for melting the quantity of butter at a liquification temperature of 175 degrees Fahrenheit of the present invention.

FIG. 14 is a flowchart illustrating the subprocess for cooling the quantity of roasted coffee beans that is infused with the quantity of butter for an extended time period of 30 mins of the present invention.

FIG. 15 is a flowchart illustrating the subprocess for cooling the quantity of roasted coffee beans that is infused with the quantity of with a refrigerator of the present invention.

FIG. 16 is a flowchart illustrating the subprocess for manufacturing a butter coffee formulation with 83.21% wt. of quantity of roasted coffee beans for the final product of the present invention.

FIG. 17 is a flowchart illustrating the subprocess for manufacturing a butter coffee formulation with 16.42% wt. of quantity of butter for the final product of the present invention.

FIG. 18 is a flowchart illustrating the subprocess for infusing a quantity of cannabidiol (CBD) with the quantity of butter of the present invention.

FIG. 19 is a flowchart illustrating the subprocess for manufacturing a butter coffee formulation with 0.15% wt. of quantity of CBD for the final product of the present invention.

### DETAIL DESCRIPTIONS OF THE INVENTION

All illustrations of the drawings are for the purpose of describing selected versions of the present invention and are not intended to limit the scope of the present invention.

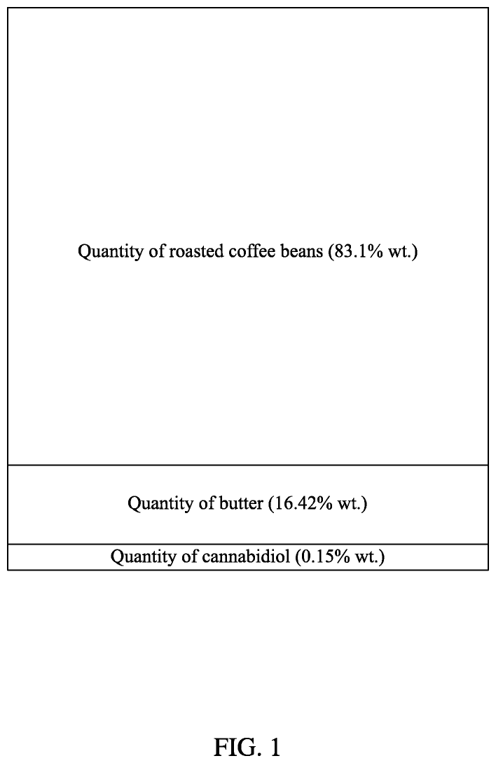

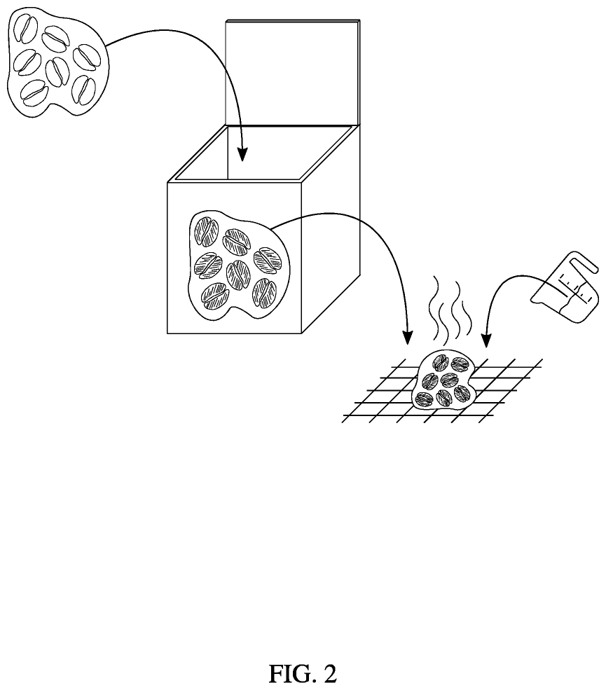

The present invention is a system and method of managing manufacturing a butter coffee formulation with a creamy texture and full-bodied flavor. The butter coffee formulation of the present invention may be consumed as a replacement for a breakfast meal or simply as a treat throughout the day. The system and method of manufacturing significantly enhances the flavor of dried coffee beans without burning the dried coffee beans. Furthermore, the system and method of manufacturing a butter coffee formulation produces a quantity of roasted coffee beans that is ready for brewing and requires no additional add-ons such as milk or creamer in order to have a smooth cup of coffee. Thus, the physical system used to implement the method for the present invention includes a quantity of dried coffee beans, a quantity of butter, a roasting machine, and a cooling tray (Step A), seen in FIG. 1 and FIG. 2. The quantity of dried coffee beans are dried seeds of coffee plant that may originate from a variety of regions that grow and harvest coffee plant. The quantity of dried coffee beans may provide at least one cup of coffee that is delicate in flavor with low acidity or at least one cup of coffee that is high in flavor with high acidity. The quantity of butter is preferably unsalted such that the flavor of the butter coffee formulation is not altered by salted butter. Furthermore, the quantity of butter provides a creamy texture. The roasting machine roasts the quantity of dried coffee beans and creates a full-bodied flavor for a cup of brewed coffee. The cooling tray allows the dried coffee beans, once roasted, to cool back to room temperature and be ready for brewing or storage.

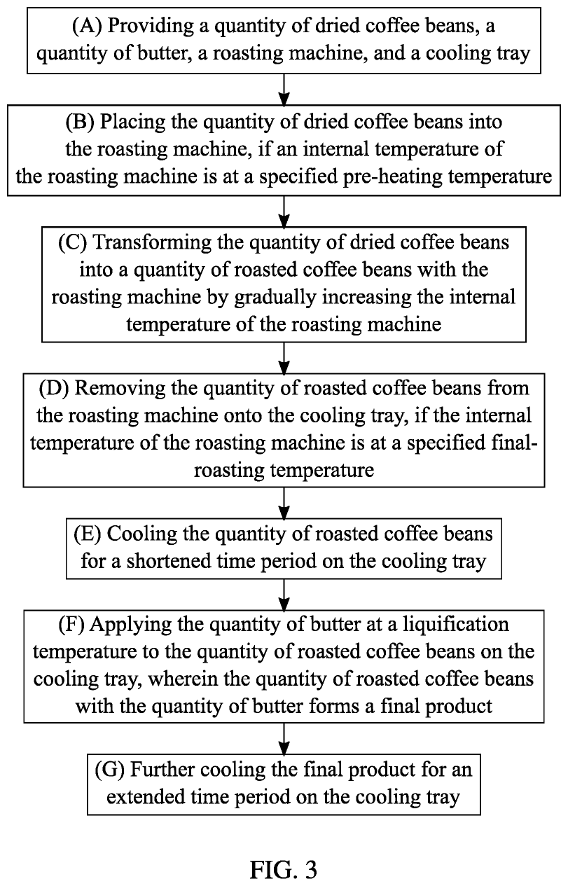

The overall process for the method of the present invention includes the following steps that are implemented with the quantity of dried coffee beans, a quantity of butter, a roasting machine, and a cooling tray. As seen in FIG. 3, in order to roast the quantity of dried coffee beans, the quantity of dried coffee beans is placed into the roasting machine, if an internal temperature of the roasting machine is at a specific pre-heating temperature (Step B). The quantity of dried coffee beans is transformed into a quantity of roasted coffee beans with the roasting machine by gradually increasing the internal temperature of the roasting machine (Step C). With each increase of temperature, the flavor of the dried coffee beans becomes more concentrated. The quantity of roasted coffee beans is then removed from the roasting machine onto the cooling tray, if the internal temperature of the roasting machine is at a specific final-roasting temperature (Step D). The specific final roasting temperature allows the flavors of the dried coffee beans to be even more concentrated for a short time after the first crack of the quantity of dried coffee beans while preserving the integrity of the quantity of dried coffee beans. The quantity of roasted coffee beans is then cooled for a shortened time period on the cooling tray so that the roasted coffee beans may be ready for brewing or storage (Step E). The integrity, and consequently the flavor, of the quantity of roasted coffee may be harmed if the overall temperature of the quantity of roasted coffee beans is too high. In order for at least one cup of coffee from the quantity of roasted coffee beans to have a creamy and full texture, the quantity of butter is applied at a liquification temperature to the quantity of roasted coffee beans on the cooling tray, wherein the quantity of roasted coffee beans with the quantity of butter forms a final product (Step F). The final product is further cooled for an extended time period on the cooling tray as the quantity of butter at a liquified temperature has increased the temperature of the quantity of roasted coffee beans once again (Step G). The extended period of time allows the quantity of coffee beans to return back to room temperature so that the quantity of coffee beans may be brewed or stored in a refrigerator or similar cooling unit.

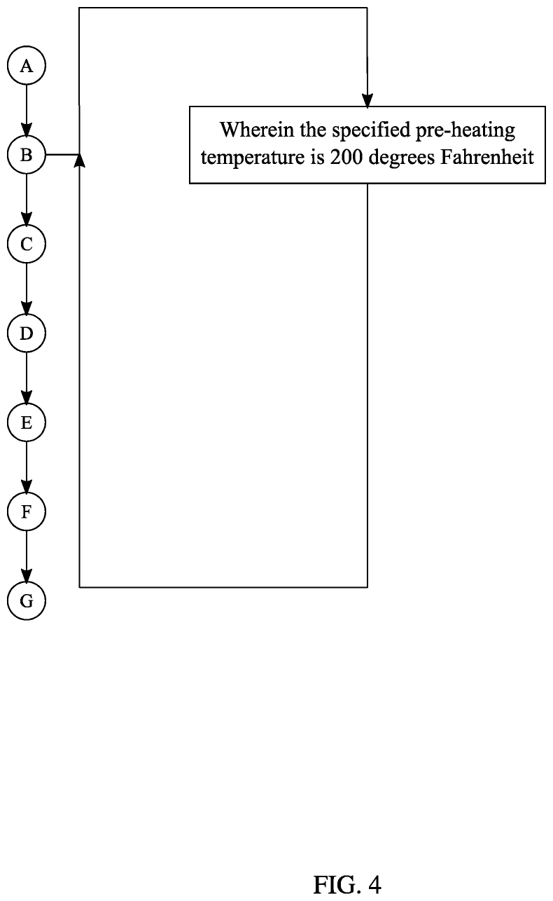

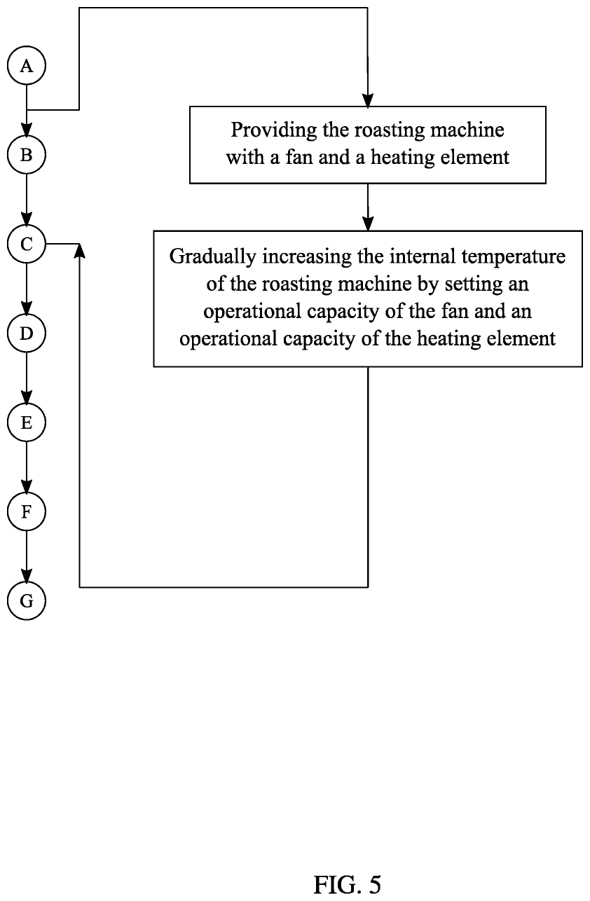

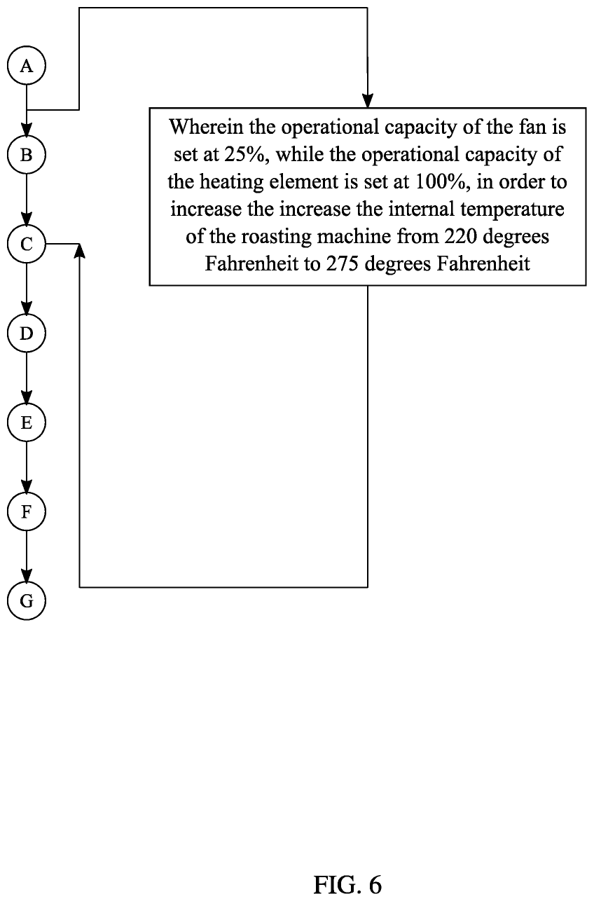

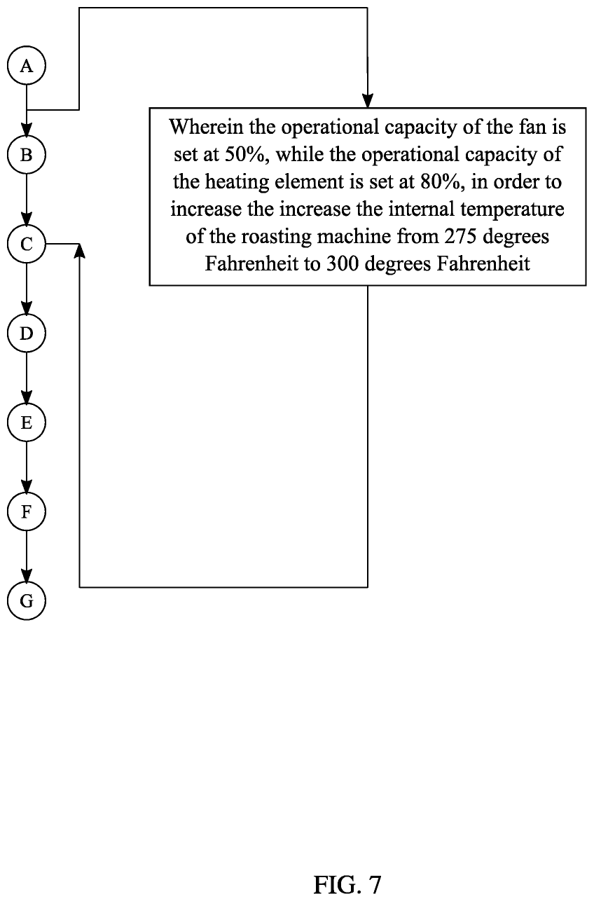

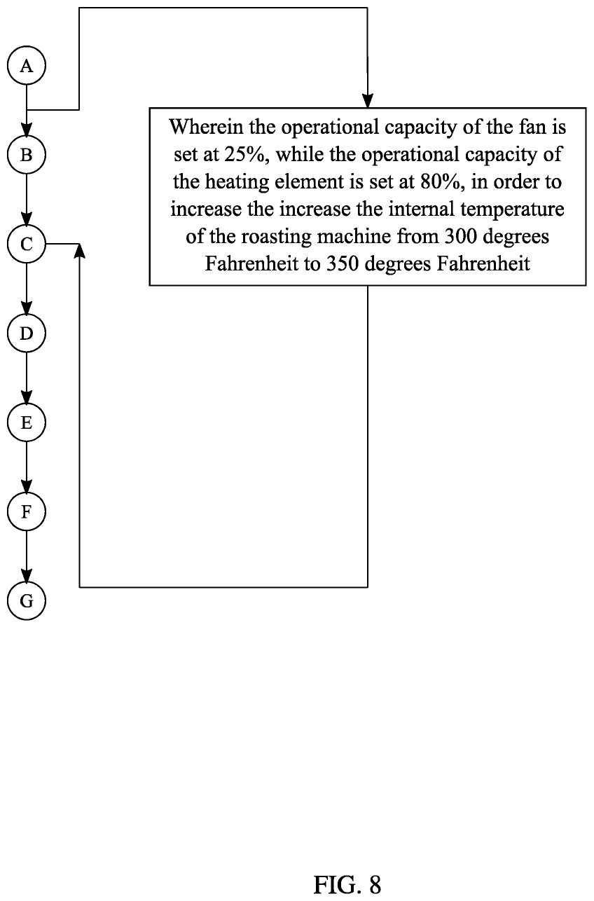

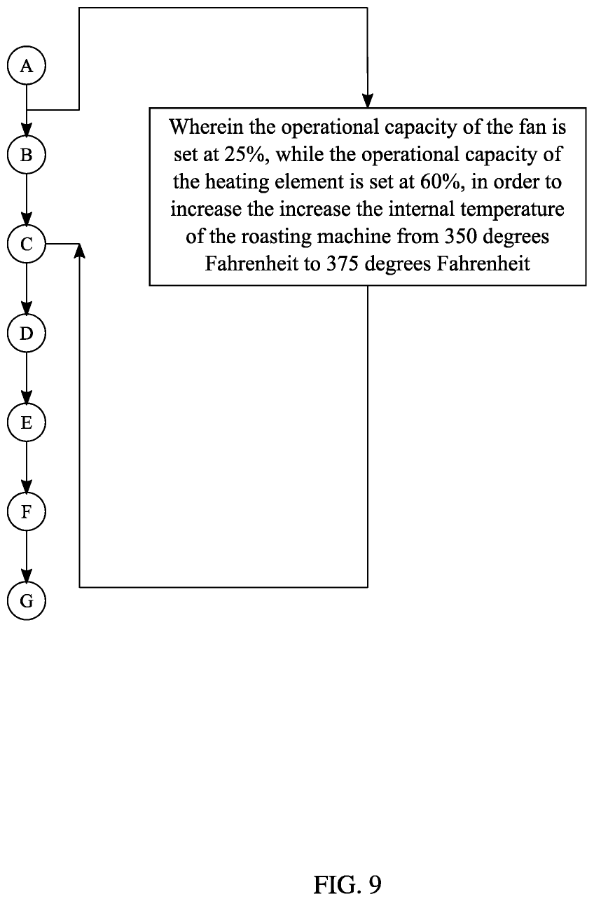

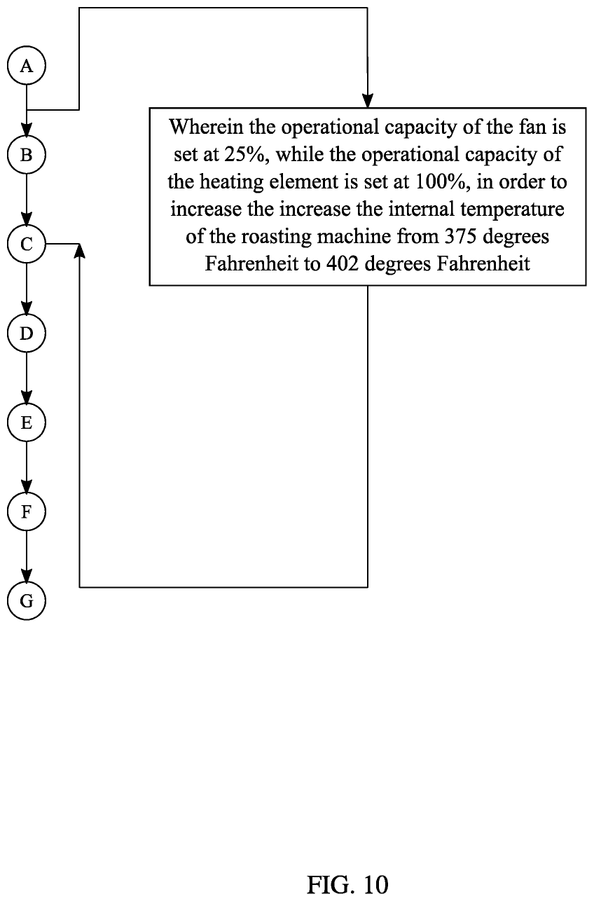

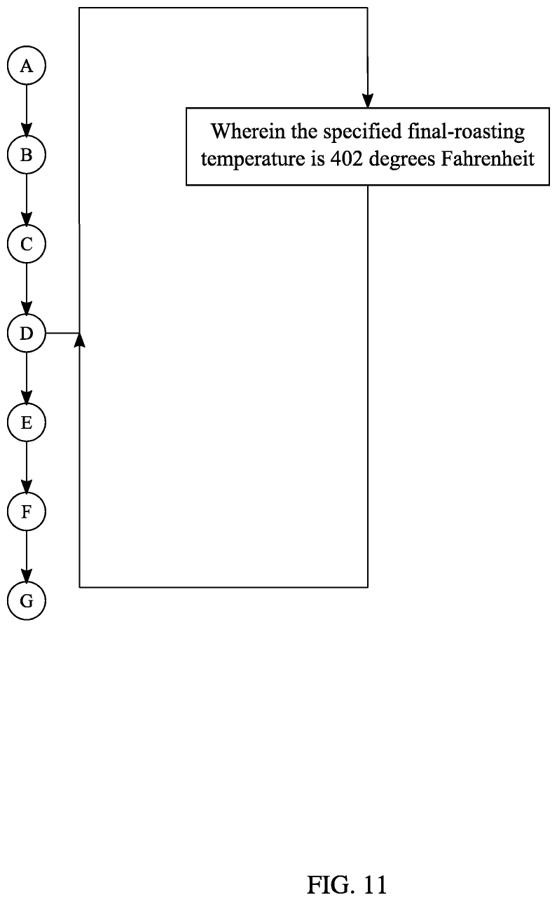

The integrity of the quantity of dried coffee beans is preserved while in the roasting machine as the specified pre-heating temperature is 200 degrees Fahrenheit, seem in FIG. 4. In order to effectively roast the quantity of dried coffee beans during the roasting process, the roasting machine is provided with a fan and a heating element. The fan directs and circulates the air within the roasting machine, and the heating element increases the temperature within the roasting machine. As seen in FIG. 5, the internal temperature is gradually increased by setting an operational capacity of the fan and an operational capacity of the heating element. The operational capacity of the fan and the operational capacity of the heating element automatically alters the intensity of the fan and the heating element in order to effectively roast the quantity of dried coffee beans. In order to increase the internal temperature of the roasting machine from 220 degrees Fahrenheit to 275 degrees Fahrenheit, the operational capacity of the fan is set at 25%, while the operational capacity of the heating element is set at 100%, seen in FIG. 6. In order to increase the internal temperature of the roasting machine from 275 degrees Fahrenheit to 300 degrees Fahrenheit, the operational capacity of the fan is set at 50%, while the operational capacity of the heating element is set at 80%, seen in FIG. 7. In order to increase the internal temperature of the roasting machine from 300 degrees Fahrenheit to 350 degrees Fahrenheit, the operational capacity of the fan is set at 25%, while the operational capacity of the heating element is set at 80%, seen in FIG. 8. In order to increase the internal temperature of the roasting machine from 350 degrees Fahrenheit to 375 degrees Fahrenheit, the operational capacity of the fan is set at 25%, while the operational capacity of the heating element is set at 60%, seen in FIG. 9. In order to increase the internal temperature of the roasting machine from 375 degrees Fahrenheit to 402 degrees Fahrenheit, the operational capacity of the fan is set at 25%, while the operational capacity of the heating element is set at 100%, seen in FIG. 10. As shown in FIG. 11, the final-roasting temperature is at 402 degrees Fahrenheit as the first crack of the quantity of dried coffee beans occurs approximately around 380 degrees Fahrenheit.

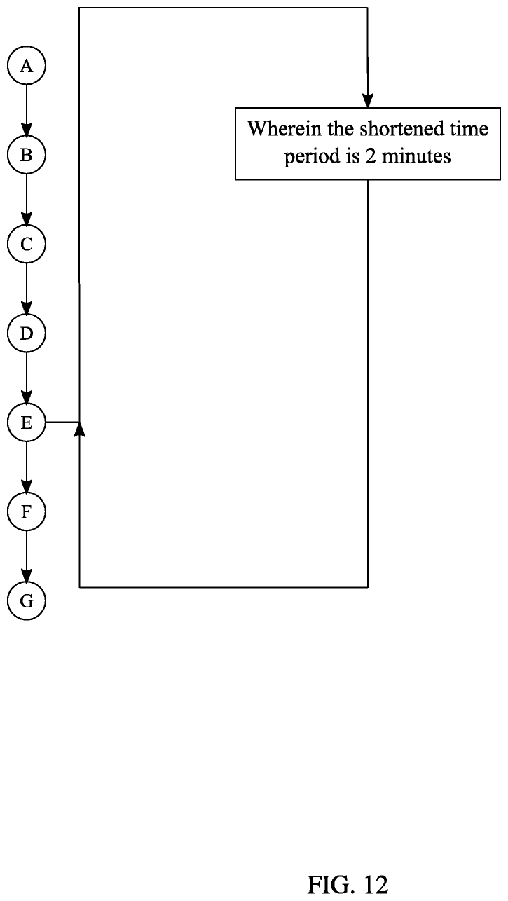

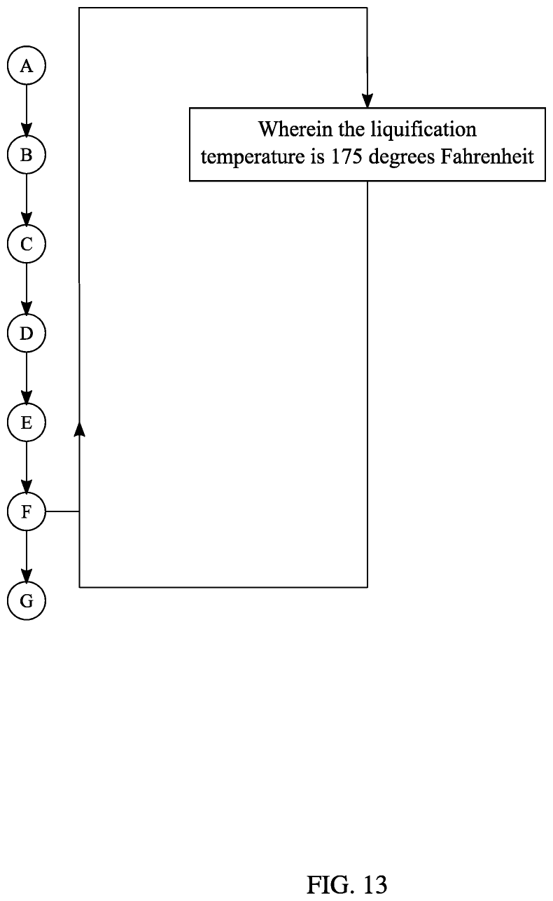

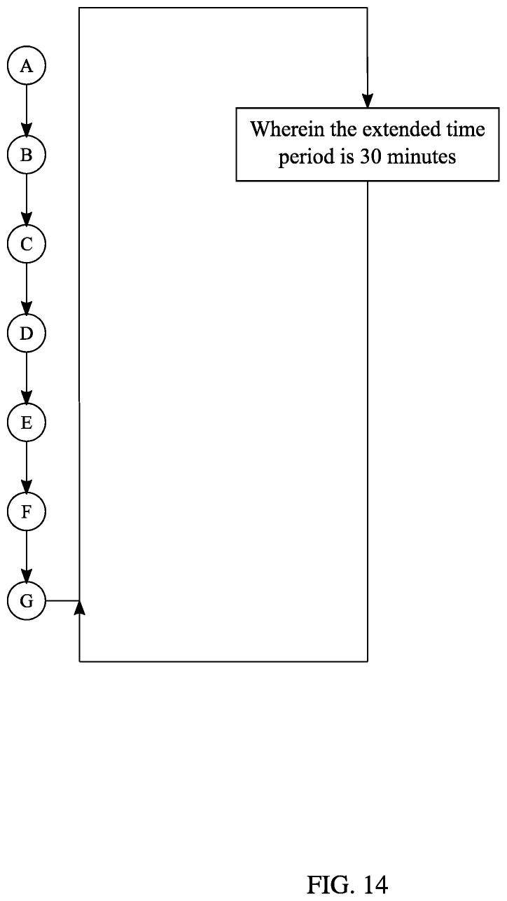

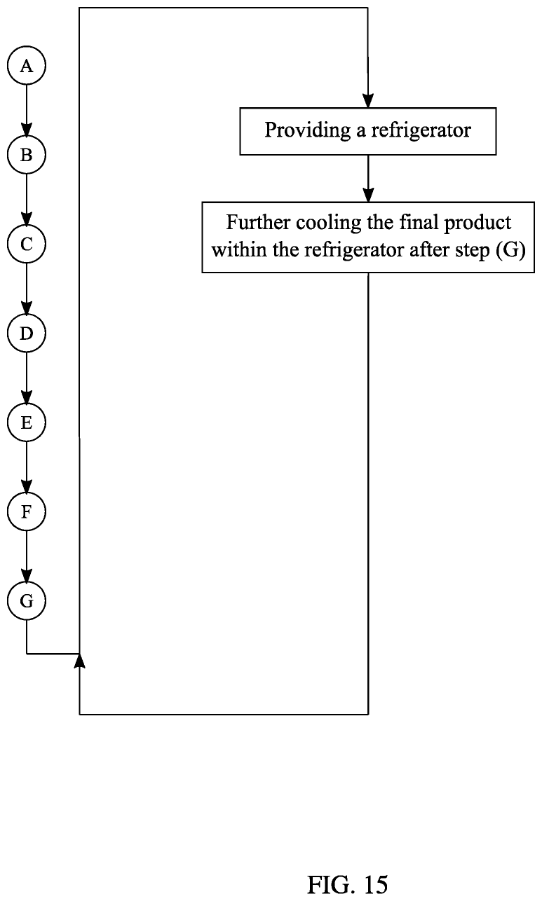

In the preferred embodiment of the present invention, the shortened time period is 2 minutes. This preferred shortened time period, seen in FIG. 12, is sufficient amount of time to allow the quantity of roasted coffee beans to cool down so that the overall temperature of the quantity of roasted coffee beans is so high once the quantity of butter is at the liquified temperature. Furthermore, in the preferred embodiment of the present invention, the liquification temperature is 175 degrees Fahrenheit, seen in FIG. 13. This preferred liquification temperature allows the quantity of better to be completely melted without altering the flavor of the quantity of butter as a result of being over heated and burnt. Furthermore, in the preferred embodiment of the present invention seen in FIG. 14, the extended time period is 30 minutes, as the overall temperature of the quantity of roasted coffee beans has once again increased as a result of the application of the quantity of butter at the liquification temperature. Once the quantity of roasted coffee beans reaches room temperature, a refrigerator is provided in order to store the quantity of roasted coffee beans, seen in FIG. 15. The refrigerator preserves the integrity and flavor of the quantity of roasted coffee beans for an extended period of time. The final product is cooled within the refrigerator after Step G.

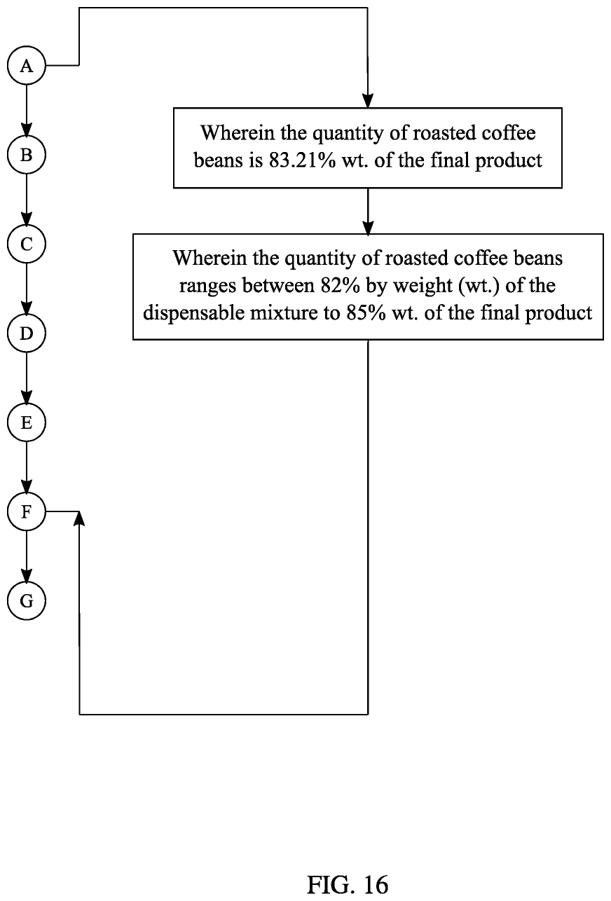

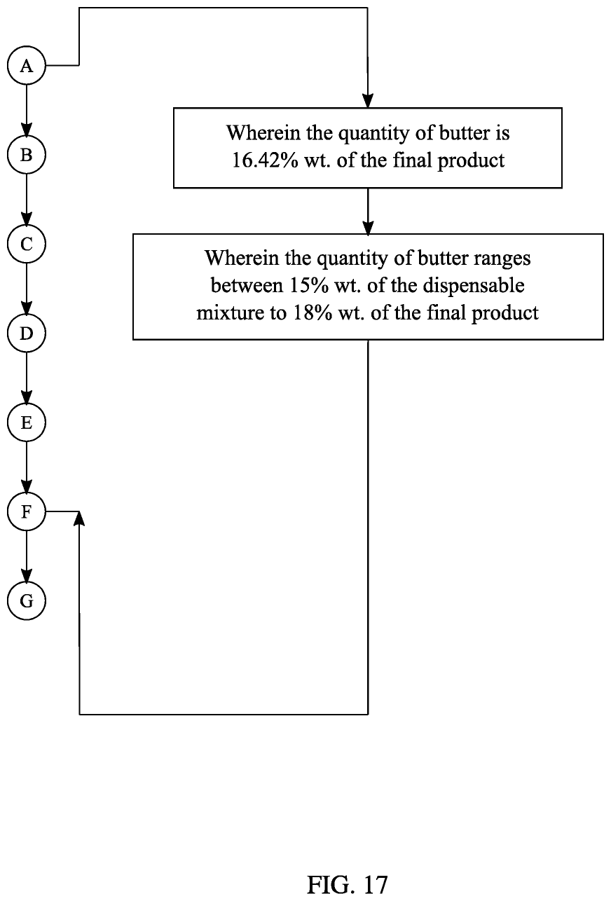

In order to produce a balanced cup of coffee, the quantity of roasted coffee beans ranges between 82% by weight (wt.) of the dispensable mixture to 85% wt. of the final product, shown in FIG. 16. As some of the dried coffee beans is lost in the roasting machine, the quantity of roasted coffee beans is 83.21% wt. of the final product. Furthermore, the quantity of butter ranges between 15% wt. of the dispensable mixture to 18% wt. of the final product, shown in FIG. 17. As some of the quantity of butter may drip off from the quantity of roasted coffee beans, the quantity of butter is 16.42% wt. of the final product.

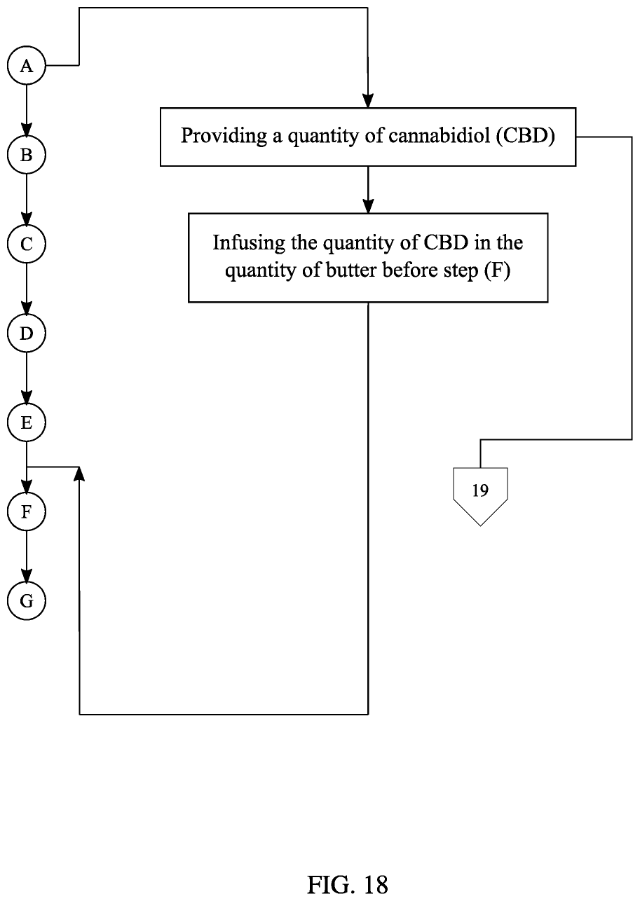

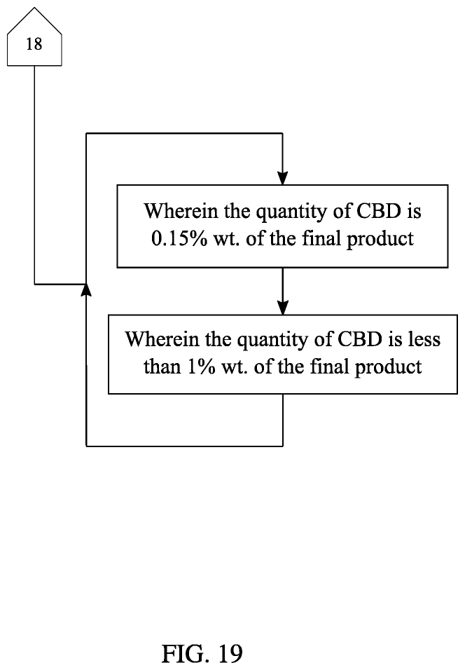

In the preferred embodiment of the present invention, a quantity of cannabidiol (CBD) is provided, seen in FIG. 18. The quantity of CBD provides relieving and soothing effects with the butter coffee formulation, enhancing the effects of consumption of the butter coffee formulation. The quantity of CBD is infused in the quantity of butter before Step F in order to effectively apply the quantity of CBD to the entire quantity of roasted coffee beans. The infusion of the quantity of CBD before Step F utilizes the temperature of the quantity of butter at the liquification temperature, allowing the quantity of CBD to be evenly and thoroughly applied with the quantity of roasted coffee beans. Due to the strength of the quantity of CBD, the quantity of CBD is less than 1% wt. of the final product. As some of the quantity of CBD may be lost during the application of Step F, the quantity of CBD is 0.15% wt. of the final product, seen in FIG. 19.

Although the invention has been explained in relation to its preferred embodiment, it is to be understood that many other possible modifications and variations can be made without departing from the spirit and scope of the invention as hereinafter claimed.

What is claimed is:

1. A method of manufacturing a butter coffee formulation, the method comprises the steps:
(A) providing a quantity of dried coffee beans, a quantity of butter, a roasting machine, and a cooling tray;
(B) placing the quantity of dried coffee beans into the roasting machine, if an internal temperature of the roasting machine is at a specified pre-heating temperature;
(C) transforming the quantity of dried coffee beans into a quantity of roasted coffee beans with the roasting machine by gradually increasing the internal temperature of the roasting machine;
(D) removing the quantity of roasted coffee beans from the roasting machine onto the cooling tray, if the internal temperature of the roasting machine is at a specified final-roasting temperature;
(E) cooling the quantity of roasted coffee beans for a shortened time period on the cooling tray;
(F) applying the quantity of butter at a liquification temperature to the quantity of roasted coffee beans on the cooling tray, wherein the quantity of roasted coffee beans with the quantity of butter forms a final product; and,
(G) further cooling the final product for an extended time period on the cooling tray.

2. The method of manufacturing a butter coffee formulation, the method as claimed in claim 1, wherein the specified pre-heating temperature is 200 degrees Fahrenheit.

3. The method of manufacturing a butter coffee formulation, the method as claimed in claim 1, the method as claimed in claim 1 comprises the steps of:
providing the roasting machine with a fan and a heating element; and,
gradually increasing the internal temperature of the roasting machine by setting an operational capacity of the fan and an operational capacity of the heating element.

4. The method of manufacturing a butter coffee formulation, the method as claimed in claim 3, wherein the operational capacity of the fan is set at 25%, while the operational capacity of the heating element is set at 100%, in order to increase the increase the internal temperature of the roasting machine from 220 degrees Fahrenheit to 275 degrees Fahrenheit.

5. The method of manufacturing a butter coffee formulation, the method as claimed in claim 3, wherein the operational capacity of the fan is set at 50%, while the operational capacity of the heating element is set at 80%, in order to increase the increase the internal temperature of the roasting machine from 275 degrees Fahrenheit to 300 degrees Fahrenheit.

6. The method of manufacturing a butter coffee formulation, the method as claimed in claim 3, wherein the operational capacity of the fan is set at 25%, while the operational capacity of the heating element is set at 80%, in order to increase the increase the internal temperature of the roasting machine from 300 degrees Fahrenheit to 350 degrees Fahrenheit.

7. The method of manufacturing a butter coffee formulation, the method as claimed in claim 3, wherein the operational capacity of the fan is set at 25%, while the operational capacity of the heating element is set at 60%, in order to increase the increase the internal temperature of the roasting machine from 350 degrees Fahrenheit to 375 degrees Fahrenheit.

8. The method of manufacturing a butter coffee formulation, the method as claimed in claim 3, wherein the operational capacity of the fan is set at 25%, while the operational capacity of the heating element is set at 100%, in order to increase the increase the internal temperature of the roasting machine from 375 degrees Fahrenheit to 402 degrees Fahrenheit.

9. The method of manufacturing a butter coffee formulation, the method as claimed in claim 1, wherein the specified final-roasting temperature is 402 degrees Fahrenheit.

10. The method of manufacturing a butter coffee formulation, the method as claimed in claim 1, wherein the shortened time period is 2 minutes.

11. The method of manufacturing a butter coffee formulation, the method as claimed in claim 1, wherein the liquification temperature is 175 degrees Fahrenheit.

12. The method of manufacturing a butter coffee formulation, the method as claimed in claim 1, wherein the extended time period is 30 minutes.

13. The method of manufacturing a butter coffee formulation, the method as claimed in claim 1 comprises the steps of:
providing a refrigerator; and,
further cooling the final product within the refrigerator after step (G);

14. The method of manufacturing a butter coffee formulation, the method as claimed in claim 1, wherein the quantity of roasted coffee beans ranges between 82% by weight (wt.) of the dispensable mixture to 85% wt. of the final product.

15. The method of manufacturing a butter coffee formulation, the method as claimed in claim 14, wherein the quantity of roasted coffee beans is 83.21% wt. of the final product.

16. The method of manufacturing a butter coffee formulation, the method as claimed in claim 1, wherein the quantity of butter ranges between 15% wt. of the dispensable mixture to 18% wt. of the final product.

17. The method of manufacturing a butter coffee formulation, the method as claimed in claim 16, wherein the quantity of butter is 16.42% wt. of the final product.

18. The method of manufacturing a butter coffee formulation, the method as claimed in claim 1 comprises the steps of:
providing a quantity of cannabidiol (CBD); and,
infusing the quantity of CBD in the quantity of butter before step (F);

19. The method of manufacturing a butter coffee formulation, the method as claimed in claim 18, wherein the quantity of CBD is less than 1% wt. of the final product.

20. The method of manufacturing a butter coffee formulation, the method as claimed in claim 19, wherein the quantity of CBD is 0.15% wt. of the final product.
